(19) United States
(12) Patent Application Publication
(10) Pub. No.: US 2014/0360155 A1
(43) Pub. Date: Dec. 11, 2014

(54) MICROCHANNEL SYSTEMS AND METHODS FOR COOLING TURBINE COMPONENTS OF A GAS TURBINE ENGINE

(71) Applicant: General Electric Company, Schenectady, NY (US)

(72) Inventors: David Wayne Weber, Greenville, SC (US); Aaron Ezekiel Smith, Greenville, SC (US)

(21) Appl. No.: 13/912,582

(22) Filed: Jun. 7, 2013

(51) Int. Cl. F02C 7/18

(52) U.S. Cl. CPC F02C 7/18
USPC 60/39.83; 29/888.02

(57) ABSTRACT

The present application and the resultant patent thus provide a microchannel system for cooling a hot gas path surface of a turbine. The microchannel system may include a turbine component having an outer surface extending along a hot gas path of the turbine, a microchannel defined within the turbine component and extending about the outer surface, and a number of pockets defined within the turbine component and positioned along the microchannel. The present application and the resultant patent further provide a method of forming a microchannel system for cooling a hot gas path surface of a turbine. The method may include the steps of forming a turbine component having an outer surface extending along a hot gas path of the turbine, defining a microchannel within the turbine component and extending about the outer surface, and defining a number of pockets within the turbine component and positioned along the microchannel.

### TECHNICAL FIELD

The present application and the resultant patent relate generally to gas turbine engines and more particularly relate to microchannel systems and methods for cooling turbine components of a gas turbine engine at high operating temperatures.

### BACKGROUND OF THE INVENTION

In a gas turbine engine, hot combustion gases generally flow from one or more combustors through a transition piece and along a hot gas path. A number of turbine stages typically may be disposed in series along the hot gas path so that the combustion gases flow through first-stage nozzles and buckets and subsequently through nozzles and buckets of later stages of the turbine. In this manner, the nozzles may direct the combustion gases toward the respective buckets, causing the buckets to rotate and drive a load, such as an electrical generator and the like. The combustion gases may be contained by circumferential shrouds surrounding the buckets, which also may aid in directing the combustion gases along the hot gas path. In this manner, the turbine nozzles, buckets, and shrouds may be subjected to high temperatures resulting from the combustion gases flowing along the hot gas path, which may result in the formation of hot spots and high thermal stresses in these components. Because the efficiency of a gas turbine engine is dependent on its operating temperatures, there is an ongoing demand for components positioned within and along the hot gas path, such as turbine nozzles, buckets, and shrouds to be capable of withstanding increasingly higher temperatures without deterioration, failure, or decrease in useful life.

Certain turbine components, particularly those of later turbine stages, may include a number of microchannels extending through the components for cooling purposes. Specifically, the microchannels may be formed as very small channels positioned near a hot surface of the components. In this manner, the microchannels may transport a cooling fluid, such as compressor bleed air, through the turbine components for exchanging heat in order to maintain the temperature of the hot surface region within an acceptable range. Because of the small size of the microchannels, the cooling fluid may be heated rapidly over a relatively short length of travel and thus may need to be expelled from the microchannels and possibly replaced by unused cooling fluid.

Certain microchannel configurations may include a number of fluid inlet holes and fluid outlet holes positioned along each microchannel to allow cooling fluid to enter and exit the microchannel as needed. The fluid inlet holes may extend between the microchannel and a fluid feed cavity, and the fluid outlet holes may extend between the microchannel and a fluid sink. According to one known microchannel configuration, the fluid inlet holes and fluid outlet holes may be drilled as straight holes extending to certain locations along the microchannel. Because of the small size of the microchannel, formation of the fluid inlet holes and fluid outlet holes by conventional drilling techniques may be particularly challenging and may result in substantial fallout of mis-drilled components and associated manufacturing cost. Moreover, formation of the fluid inlet holes and fluid outlet holes extending to certain locations along the microchannel may not be possible by conventional drilling techniques where there is no direct line of sight between such locations and the respective fluid feed cavity or fluid sink.

There is thus a desire for an improved microchannel configuration for cooling turbine components of a gas turbine engine at high operating temperatures. Specifically, such a microchannel configuration may allow for reliable formation of fluid inlet holes and fluid outlet holes by conventional drilling techniques and thus may reduce fallout and associated manufacturing cost. Such a microchannel configuration also may allow for formation of fluid inlet holes and fluid outlet holes extending to certain locations along the microchannel where there is no direct line of sight between such locations and the respective fluid feed cavity or fluid sink and thus may improve cooling of the turbine components at high operating temperatures. Ultimately, such a microchannel configuration may increase overall efficiency of the gas turbine engine without the need to develop new drilling techniques.

### SUMMARY OF THE INVENTION

The present application and the resultant patent thus provide a microchannel system for cooling a hot gas path surface of a turbine. The microchannel system may include a turbine component having an outer surface extending along a hot gas path of the turbine, a microchannel defined within the turbine component and extending about the outer surface, and a number of pockets defined within the turbine component and positioned along the microchannel.

The present application and the resultant patent further provide a method of forming a microchannel system for cooling a hot gas path surface of a turbine. The method may include the steps of forming a turbine component having an outer surface extending along a hot gas path of the turbine, defining a microchannel within the turbine component and extending about the outer surface, and defining a number of pockets within the turbine component and positioned along the microchannel.

The present application and the resultant patent further provide a microchannel system for cooling a hot gas path surface of a turbine. The microchannel system may include a turbine component having an outer surface extending along a hot gas path of the turbine, a number of microchannels defined within the turbine component and extending about the outer surface, and a number of pockets defined within the turbine component and positioned along each of the microchannels.

These and other features and improvements of the present application and the resultant patent will become apparent to one of ordinary skill in the art upon review of the following detailed description when taken in conjunction with the several drawings and the appended claims.

### BRIEF DESCRIPTION OF THE DRAWINGS

FIG. 1 is a schematic diagram of a gas turbine engine including a compressor, a combustor, and a turbine.

FIG. 2 is a side cross-sectional view of a portion of a turbine as may be used in the gas turbine engine of FIG. 1, showing a number of turbine stages.

FIG. 3 is a plan view of an embodiment of a microchannel system as may be described herein, showing a portion of a turbine component including microchannels and pockets illustrated by hidden lines.

FIG. 4 is a cross-sectional view of the microchannel system of FIG. 3, taken along line 4-4.

FIG. 5 is a cross-sectional view of the microchannel system of FIG. 3, taken along line 5-5.

FIG. 6 is a plan view of an embodiment of a microchannel system as may be described herein, showing a portion of a turbine component including microchannels and pockets illustrated by hidden lines.

FIG. 7 is a cross-sectional view of the microchannel system of FIG. 6, taken along line 7-7.

FIG. 8 is a cross-sectional view of the microchannel system of FIG. 6, taken along line 8-8.

FIG. 9 is a side view of an embodiment of a microchannel system as may be described herein, showing a portion of a turbine shroud including a microchannel and pockets illustrated by hidden lines.

FIG. 10 is a cross-sectional view of the microchannel system of FIG. 9, taken along line 10-10.

FIG. 11 is a side view of an embodiment of a microchannel system as may be described herein, showing a portion of a turbine nozzle including microchannels and pockets illustrated by hidden lines.

FIG. 12 is a side view of an embodiment of a microchannel system as may be described herein, showing a portion of a turbine bucket including microchannels and pockets illustrated by hidden lines.

### DETAILED DESCRIPTION

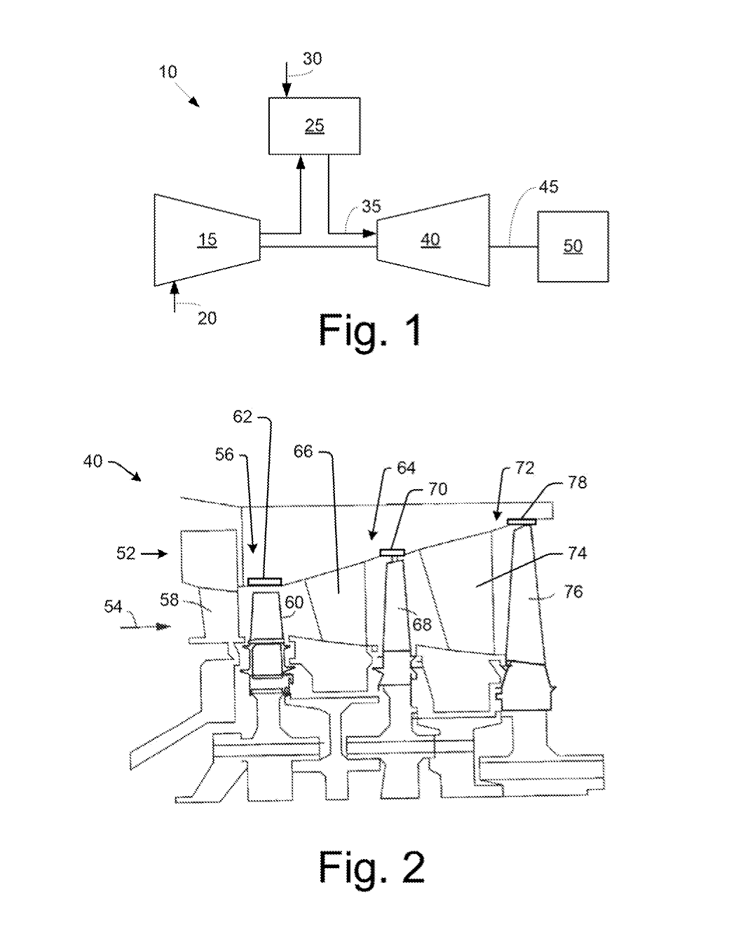

Referring now to the drawings, in which like numerals refer to like elements throughout the several views, FIG. 1 shows a schematic view of a gas turbine engine 10 as may be used herein. The gas turbine engine 10 may include a compressor 15. The compressor 15 compresses an incoming flow of air 20. The compressor 15 delivers the compressed flow of air 20 to a combustor 25. The combustor 25 mixes the compressed flow of air 20 with a pressurized flow of fuel 30 and ignites the mixture to create a flow of combustion gases 35. Although only a single combustor 25 is shown, the gas turbine engine 10 may include any number of combustors 25. The flow of combustion gases 35 is in turn delivered to a turbine 40. The flow of combustion gases 35 drives the turbine 40 so as to produce mechanical work. The mechanical work produced in the turbine 40 drives the compressor 15 via a shaft 45 and an external load 50 such as an electrical generator and the like. Other configurations and other components may be used herein.

The gas turbine engine 10 may use natural gas, various types of syngas, and/or other types of fuels. The gas turbine engine 10 may be any one of a number of different gas turbine engines offered by General Electric Company of Schenectady, N.Y., including, but not limited to, those such as a 7 or a 9 series heavy duty gas turbine engine and the like. The gas turbine engine 10 may have different configurations and may use other types of components. Other types of gas turbine engines also may be used herein. Multiple gas turbine engines, other types of turbines, and other types of power generation equipment also may be used herein together. Although the gas turbine engine 10 is shown herein, the present application may be applicable to any type of turbo machinery.

FIG. 2 shows a side cross-sectional view of a portion of the turbine 40 including a number of stages 52 positioned in a hot gas path 54 of the gas turbine engine 10. A first stage 56 may include a number of circumferentially-spaced first-stage nozzles 58 and a number of circumferentially-spaced first-stage buckets 60. The first stage 56 also may include a first-stage shroud 62 extending circumferentially and surrounding the first-stage buckets 60. The first-stage shroud 62 may include a number of shroud segments positioned adjacent one another in an annular arrangement. In a similar manner, a second stage 64 may include a number of second-stage nozzles 66, a number of second-stage buckets 68, and a second-stage shroud 70 surrounding the second-stage buckets 68. Further, a third stage 72 may include a number of third-stage nozzles 74, a number of third-stage buckets 76, and a third-stage shroud 78 surrounding the third-stage buckets 76. Although the portion of the turbine 40 is shown as including three stages 52, the turbine 40 may include any number of stages 52.

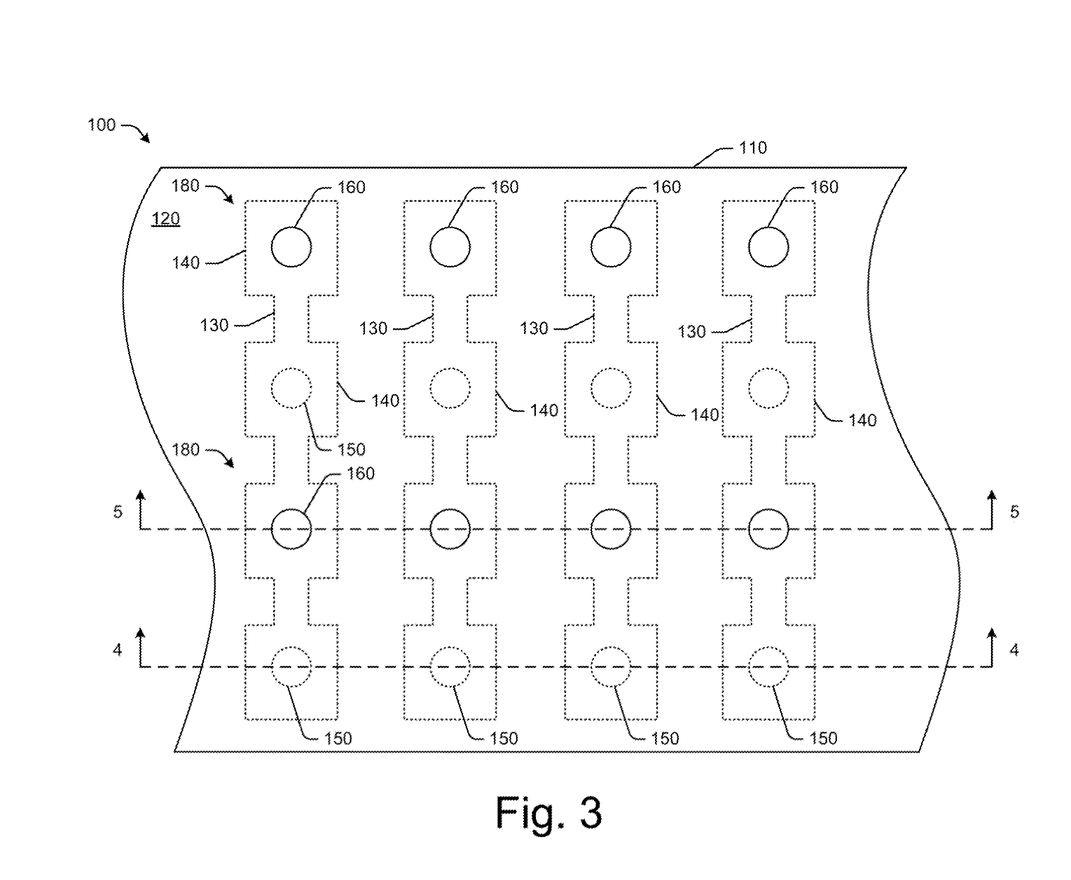

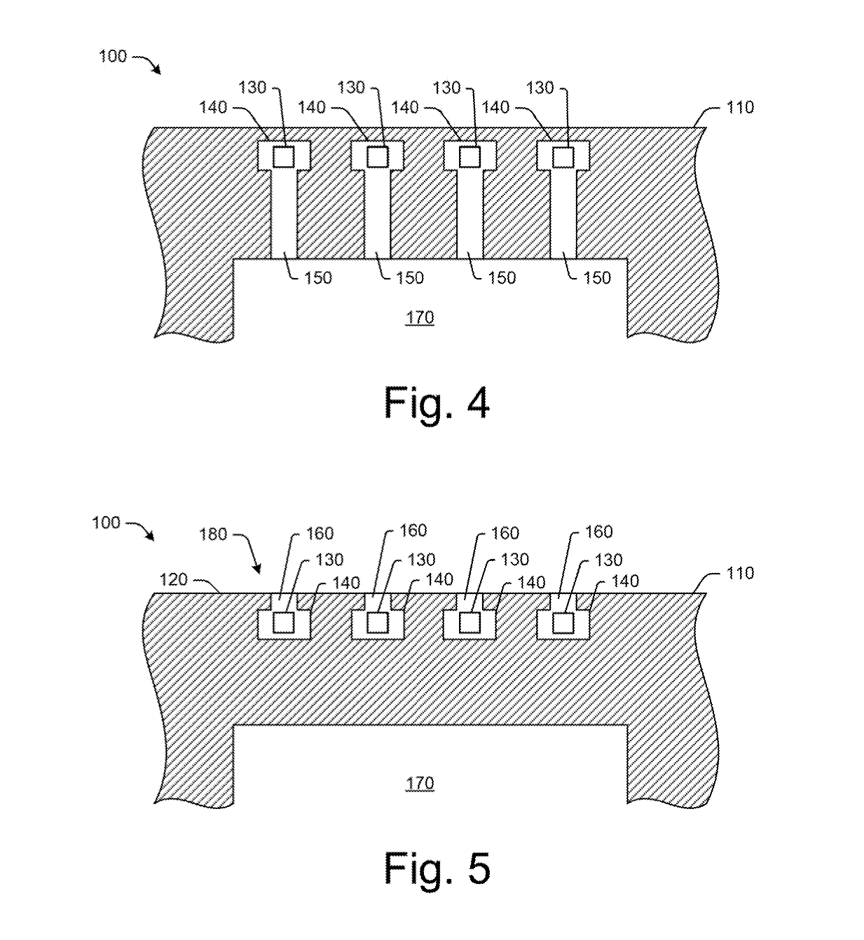

FIGS. 3-5 show an embodiment of a microchannel system 100 as may be described herein. The microchannel system 100 may be used in the turbine 40 of the gas turbine engine 10 for cooling a hot gas path surface of the turbine 40. The microchannel system 100 may include a turbine component 110 including an outer surface 120 extending along the hot gas path 54 of the turbine 40. In certain aspects, the turbine component 110 may be a turbine shroud, a turbine nozzle, a turbine bucket, or any other component positioned within or along the hot gas path 54 of the turbine 40. The outer surface 120 may face the hot gas path 54, and thus the outer surface 120 may be a hot surface of the turbine component 110 subjected to high temperatures resulting from combustion gases flowing along the hot gas path 54.

The microchannel system 100 also may include one or more microchannels 130 defined within the turbine component 110 and extending about the outer surface 120 to allow a cooling fluid to flow therethrough. Each microchannel 130 may be formed as a very small channel positioned near the outer surface 120. Specifically, each microchannel 130 may have a width between approximately 100 microns (μm) and 2 millimeters (mm) and a depth between approximately 100 μm and 2 mm. The width and the depth may be constant or substantially constant along a length of the microchannel 130. Alternatively, the width and/or the depth may vary along the length of the microchannel 130. In certain aspects, as is shown, the microchannels 130 may have a square or rectangular cross-sectional shape. In other aspects, the microchannels 130 may have a circular, semicircular, curved, triangular, rhomboidal, or other polygonal cross-sectional shape. Indeed, the microchannels 130 may have any regular or irregular cross-sectional shape, as may be desired for accommodating the geometry of the turbine component 110 or for enhancing cooling of the turbine component 110. The cross-sectional shape of each microchannel 130 may be constant or substantially constant along the length of the microchannel 130, or the cross-sectional shape may vary along the length of the microchannel 130. In this manner, a cross-sectional area of the microchannel 130 may be constant or substantially constant along the length of the microchannel 130, or the cross-sectional area may vary along the length of the microchannel 130. In certain aspects, as is shown, the microchannel 130 may define a straight path along the length of the microchannel 130. Alternatively, the microchannel 130 may define a curved path along the length of the microchannel 130.

The microchannel system 100 further may include a number of pockets 140 defined within the turbine component 110 and positioned along one or more of the microchannels 130, as is shown. Specifically, the pockets 140 may be spaced apart along the length of the microchannel 130. In certain aspects, the pockets 140 may be evenly spaced along the length of the microchannel 130 such that spacing distances between adjacent pockets 140 are equal or substantially equal. Alternatively, the pockets 140 may be unevenly spaced or staggered along the length of the microchannel 130 such that spacing distances between adjacent pockets 140 vary along the length of the microchannel 130. In certain aspects, as is shown, one or more of the pockets 140 may encompass a portion of the microchannel 130 along the length of the microchannel 130. In other words, the pocket 140 may extend outward beyond the sides of the microchannel 130 such that a width and a depth of the pocket 140 are greater than the width and the depth of the microchannel 130. The width of each pocket 140 may be between approximately 200 μm and 4 mm and the depth of each pocket 140 may be between approximately 200 μm and 4 mm. The width and the depth may be constant or substantially constant along a length of the pocket 140. Alternatively, the width and/or the depth may vary along the length of the pocket 140. In certain aspects, as is shown, the pockets 140 may have a square or rectangular cross-sectional shape. In other aspects, the pockets 140 may have a circular, semicircular, curved, triangular, rhomboidal, or other polygonal cross-sectional shape. Indeed, the pockets 140 may have any regular or irregular cross-sectional shape, as may be desired for accommodating the geometry of the turbine component 110. The cross-sectional shape of each pocket 140 may be constant or substantially constant along the length of the pocket 140, or the cross-sectional shape may vary along the length of the pocket 140. In this manner, a cross-sectional area of the pocket 140 may be constant or substantially constant along the length of the pocket 140, or the cross-sectional area may vary along the length of the pocket 140. As is shown, the microchannel 130 may have a first cross-sectional area and the pocket 140 may have a second cross-sectional area, wherein the second cross sectional area is greater than the first cross-sectional area.

The microchannel system 100 also may include one or more fluid inlet holes 150 and one or more fluid outlet holes 160 positioned along each microchannel 130 to allow cooling fluid to enter and exit the microchannel 130. Each fluid inlet hole 150 may be defined within the turbine component 110 and may extend between one of the pockets 140 and a fluid feed cavity 170 defined by the turbine component 110. The fluid feed cavity 170 may receive cooling fluid from a fluid source. For example, the fluid feed cavity 170 may receive a flow of high-pressure compressor discharge or extraction air from any stage of the compressor 15. In a similar manner, each fluid outlet hole 160 may be defined within the turbine component 110 and may extend between one of the pockets 140 and a fluid sink 180 defined by the turbine component 110. In one example, the fluid sink 180 may be in fluid communication with the hot gas path 54, such that the cooling fluid is exhausted into the hot gas path 54. In another example, where the fluid feed cavity 170 receives a flow of extraction air from one stage of the compressor 15, the fluid sink 180 may be in fluid communication with a compressor discharge plenum, such that the cooling fluid is exhausted into the discharge plenum and mixed therein with compressor discharge or extraction air from an earlier stage of the compressor 15. As is shown, the fluid inlet holes 150 and the fluid outlet holes 160 may define a straight path between one of the pockets and the fluid feed cavity 170 or the fluid sink 180. Accordingly, the fluid inlet holes 150 and the fluid outlet holes 160 may be formed by conventional drilling techniques. In certain aspects, there may be no direct line of sight between the fluid feed cavity 170 and the microchannel 130, although there may be a direct line of sight between the fluid feed cavity 170 and one of the pockets 140 such that the fluid inlet hole 150 may extend therebetween to allow cooling fluid to enter the microchannel 130 via the pocket 140. Similarly, in certain aspects, there may be no direct line of sight between the fluid sink 180 and the microchannel 130, although there may be a direct line of sight between the fluid sink 180 and one of the pockets 140 such that the fluid outlet hole 160 may extend therebetween to allow cooling fluid to exit the microchannel 130 via the pocket 140.

A method of forming the microchannel system 100 may include forming the turbine component 110 including the outer surface 120 extending along the hot gas path 54 of the turbine 40. The turbine component 110 may be formed by various techniques known in the art. In certain aspects, the turbine component 110 may be a turbine shroud, a turbine nozzle, a turbine bucket, or any other component positioned within or along the hot gas path 54 of the turbine 40. The method also may include defining the one or more microchannels 130 within the turbine component 110 and extending about the outer surface 120. The microchannels 130 may be defined within the turbine component 110 by a variety of techniques, including micro-machining, wire EDM, milled EDM, plunge EDM, water-jet trenching, laser trenching, or casting. Other techniques of defining the microchannels 130 may be used. The method further may include defining the number of pockets 140 within the turbine component 110 and positioned along the microchannels 130. The pockets 140 similarly may be defined by a variety of techniques, including micro-machining, wire EDM, milled EDM, plunge EDM, water jet trenching, laser trenching, or casting. Additionally, the method may include drilling the fluid inlet hole 150 defined within the turbine component 110 and extending between the fluid feed cavity 170 and one of the pockets 140. In a similar manner, the method may include drilling the fluid outlet hole 160 within the turbine component 110 and extending between the fluid sink 180 and one of the pockets 140. The fluid inlet hole 150 and the fluid outlet hole 160 may be drilled by conventional drilling techniques, and thus the holes 150, 160 may define a straight path between the pocket 140 and the fluid feed cavity 170 or the fluid sink 180, respectively.

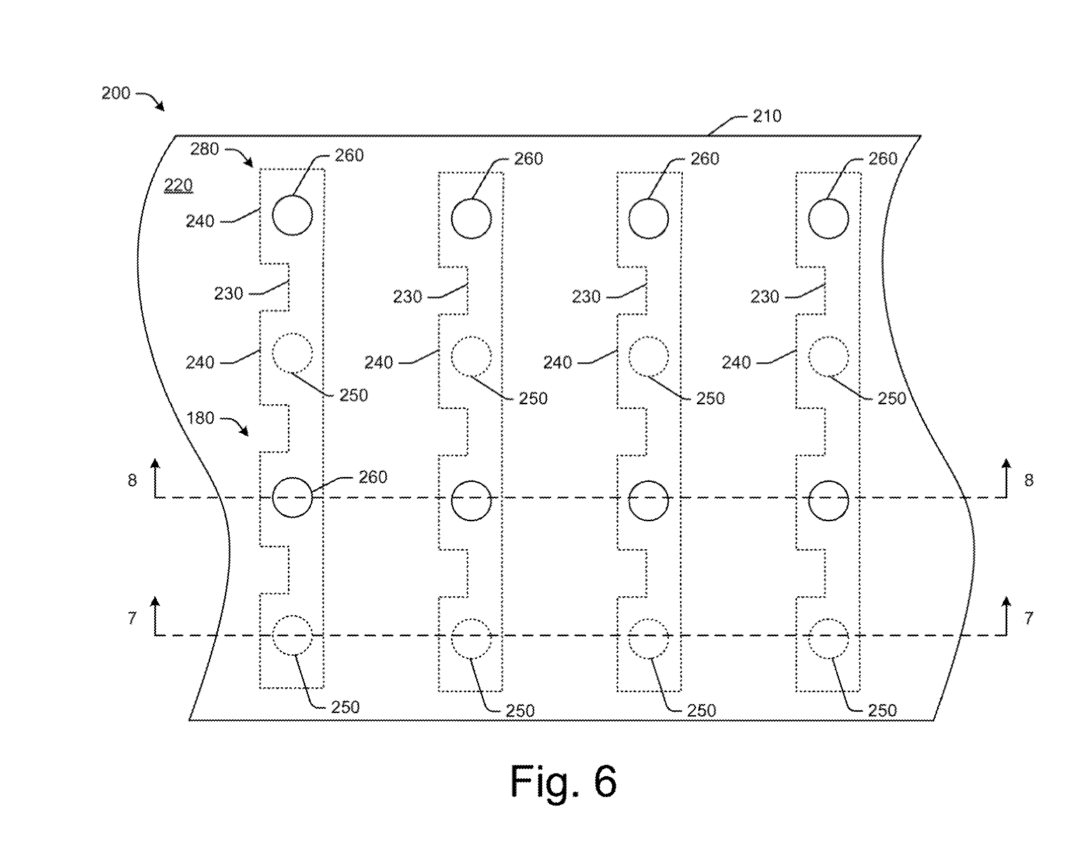

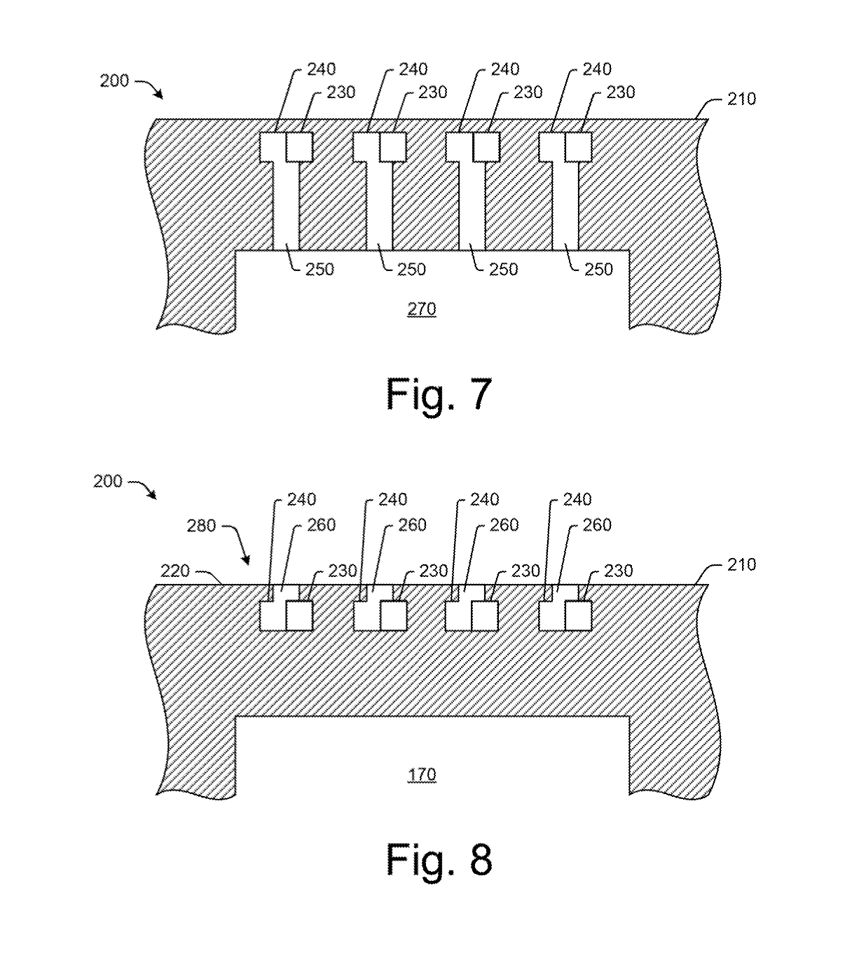

FIGS. 6-8 show another embodiment of a microchannel system 200 as may be described herein. The microchannel system 200 includes various elements corresponding to those described above with respect to the microchannel system 100, which elements are identified in FIGS. 6-8 with corresponding numerals and are not described in detail herein. The microchannel system 200 may be used in the turbine 40 of the gas turbine engine 10 for cooling a hot gas path surface of the turbine 40. The microchannel system 200 may include a turbine component 210, an outer surface 220, one or more microchannels 230, a number of pockets 240, one or more fluid inlet holes 250, one or more fluid outlet holes 260, a fluid feed cavity 270, and a fluid sink 280. These elements may be configured, sized, shaped, or formed in a manner similar to the corresponding elements of the microchannel 100 described above.

The pockets 240 may be defined within the turbine component 210 and positioned along one or more of the microchannels 230. Specifically, the pockets 240 may be spaced apart along the length of the microchannel 230. In certain aspects, the pockets 240 may be evenly spaced along the length of the microchannel 230. Alternatively, the pockets 240 may be unevenly spaced or staggered along the length of the microchannel 230. In certain aspects, as is shown, one or more of the pockets 240 may be offset to one side of the microchannel 230 along the length of the microchannel 230. In other words, the pocket 240 may extend outward beyond the one side of the microchannel 230 such that a width or a depth of the pocket 240 is greater than the width or the depth of the microchannel 230. In certain aspects, the pocket 240 may extend outward beyond the top side, bottom side, right side, or left side of the microchannel 230, as may be desired for accommodating the geometry of the turbine component 210. Moreover, in some such aspects, the pocket 240 may extend outward beyond two or more of the sides of the microchannel 230.

In certain aspects, there may be no direct line of sight between the fluid feed cavity 270 and the microchannel 230, although there may be a direct line of sight between the fluid feed cavity 270 and one of the pockets 240 because the pocket 240 may extend outward beyond one side of the microchannel 230 to provide the direct line of sight therebetween. In this manner, the fluid inlet hole 250 may define a straight path extending between the pocket 240 and the fluid feed cavity 270 to allow cooling fluid to enter the microchannel 230 via the pocket 240. Similarly, in certain aspects, there may be no direct line of sight between the fluid sink 280 and the microchannel 230, although there may be a direct line of sight between the fluid sink 280 and one of the pockets 240 because the pocket 240 may extend outward beyond one side of the microchannel 230 to provide the direct line of sight therebetween. In this manner, the fluid outlet hole 260 may define a straight path extending between the pocket 240 and the fluid sink 280 to allow cooling fluid to exit the microchannel 230 via the pocket 240.

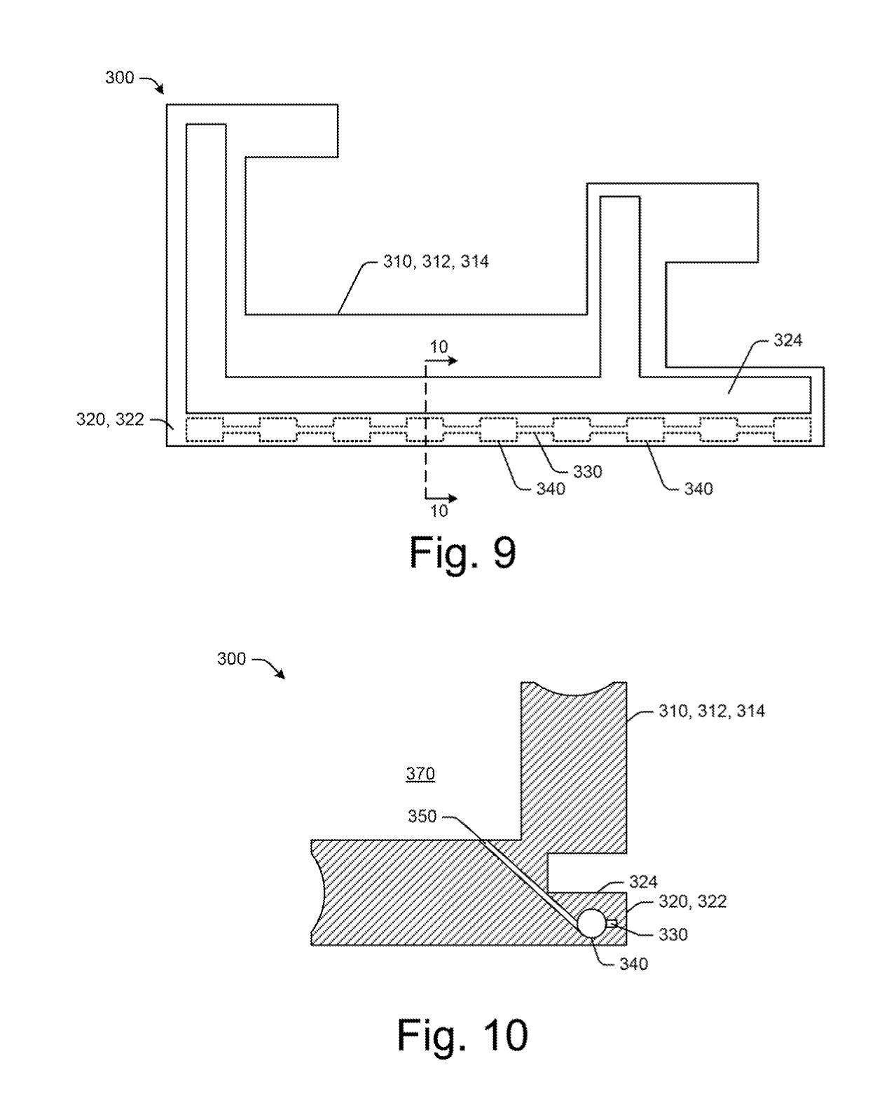

FIGS. 9 and 10 show another embodiment of a microchannel system 300 as may be described herein. The microchannel system 300 includes various elements corresponding to those described above with respect to the microchannel system 100, which elements are identified in FIGS. 9 and 10 with corresponding numerals and are not described in detail herein. The microchannel system 300 may be used in the turbine 40 of the gas turbine engine 10 for cooling a hot gas path surface of the turbine 40. The microchannel system 300 may include a turbine component 310, an outer surface 320, one or more microchannels 330, a number of pockets 340, one or more fluid inlet holes 350, one or more fluid outlet holes 360, a fluid feed cavity 370, and a fluid sink 380. These elements may be configured, sized, shaped, or formed in a manner similar to the corresponding elements of the microchannel 100 described above.

In certain aspects, the turbine component 310 may be a turbine shroud 312 or a portion thereof. Specifically, the turbine component 310 may be a turbine shroud segment 314. The outer surface 320 of the turbine shroud segment 314 may be a lateral surface 322 configured to abut a mating surface of an adjacent turbine shroud segment. The one or more microchannels 330 may extend about the lateral surface 322, as is shown. The turbine shroud segment 314 also may include a seal slot 324 defined by the turbine shroud segment 314 and extending along the lateral surface 322. The seal slot 324 may be configured for receiving a seal for sealing between the lateral surface 322 of the turbine shroud segment 314 and the mating surface of the adjacent turbine shroud segment. As is shown, there may be no direct line of sight between the fluid feed cavity 370 and the microchannel 330 because of the configuration of the seal slot 324. However, there may be a direct line of sight between the fluid feed cavity 370 and one of the pockets 340 because the pocket 340 may extend outward beyond one side of the microchannel 330 to provide the direct line of sight therebetween. In this manner, the fluid inlet hole 350 may define a straight path extending between the pocket 340 and the fluid feed cavity 370 to allow cooling fluid to enter the microchannel 330 via the pocket 340.

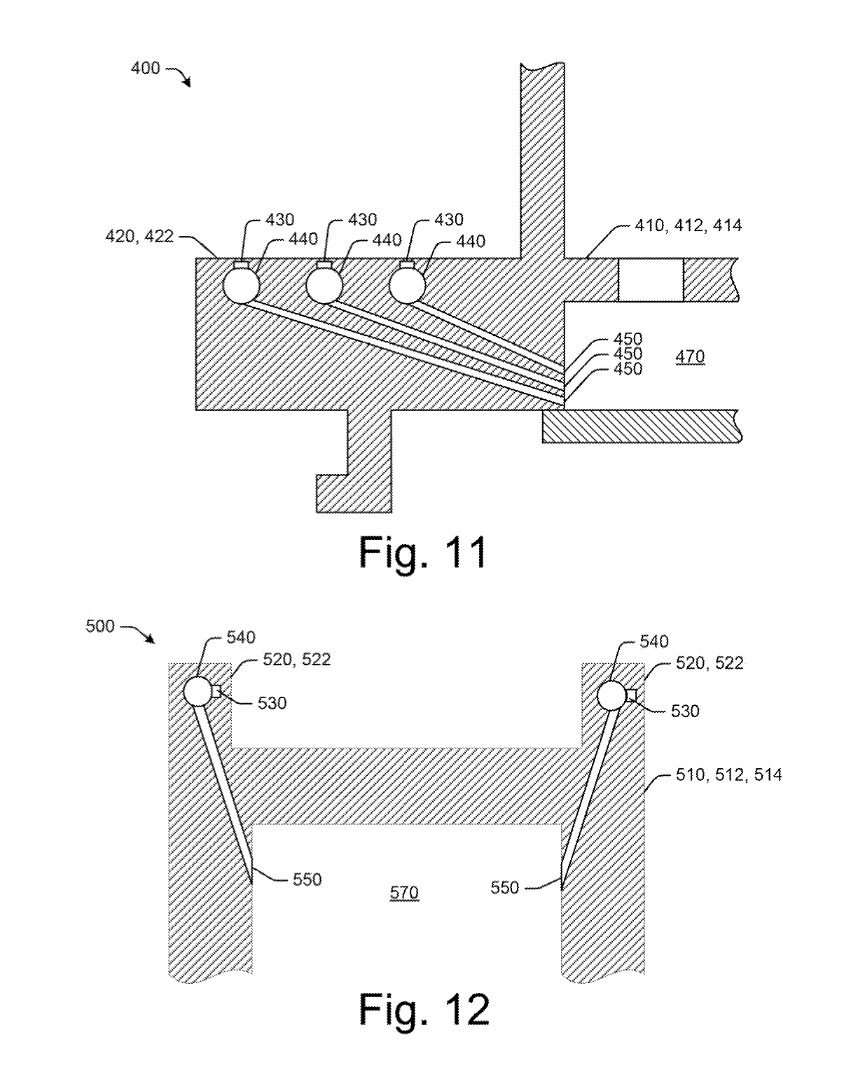

FIG. 11 shows another embodiment of a microchannel system 400 as may be described herein. The microchannel system 400 includes various elements corresponding to those described above with respect to the microchannel system 100, which elements are identified in FIG. 11 with corresponding numerals and are not described in detail herein. The microchannel system 400 may be used in the turbine 40 of the gas turbine engine 10 for cooling a hot gas path surface of the turbine 40. The microchannel system 400 may include a turbine component 410, an outer surface 420, one or more microchannels 430, a number of pockets 440, one or more fluid inlet holes 450, one or more fluid outlet holes 460, a fluid feed cavity 470, and a fluid sink 480. These elements may be configured, sized, shaped, or formed in a manner similar to the corresponding elements of the microchannel 100 described above.

In certain aspects, the turbine component 410 may be a turbine nozzle 412 or a portion thereof. Specifically, the turbine component 410 may be an inner side wall portion 414 of the turbine nozzle 412. The outer surface 420 of the inner side wall portion 414 may be positioned on a forward overhang 422 positioned along the hot gas path 54 of the turbine 40. As is shown, the one or more microchannels 430 may extend about the outer surface 420. Because of the configuration of the forward overhang 422, and the low angle of the fluid inlet hole 450 extending from the fluid feed cavity 470, reliable drilling of the fluid inlet hole 450 into the microchannel 430 may be particularly challenging. However, reliable drilling of the fluid inlet hole 450 into one of the pockets 440 along the microchannel 430 may be achieved because the pocket 440 may extend outward beyond one side of the microchannel 430 to provide a larger target for drilling. In this manner, the fluid inlet hole 450 may define a straight path extending between the pocket 440 and the fluid feed cavity 470 to allow cooling fluid to enter the microchannel 430 via the pocket 440.

FIG. 12 shows another embodiment of a microchannel system 500 as may be described herein. The microchannel system 500 includes various elements corresponding to those described above with respect to the microchannel system 100, which elements are identified in FIG. 12 with corresponding numerals and are not described in detail herein. The microchannel system 500 may be used in the turbine 40 of the gas turbine engine 10 for cooling a hot gas path surface of the turbine 40. The microchannel system 500 may include a turbine component 510, an outer surface 520, one or more microchannels 530, a number of pockets 540, one or more fluid inlet holes 550, one or more fluid outlet holes 560, a fluid feed cavity 570, and a fluid sink 580. These elements may be configured, sized, shaped, or formed in a manner similar to the corresponding elements of the microchannel 100 described above.

In certain aspects, the turbine component 510 may be a turbine bucket 512 or a portion thereof. Specifically, the turbine component 510 may be a bucket tip portion 514 of the turbine bucket 512. The bucket tip portion 514 may be configured as a squealer tip, as is known in the art. The outer surface 520 of the bucket tip portion 514 may be positioned on one or more squealer rails 522 positioned along the hot gas path 54 of the turbine 40, and the one or more microchannels 530 may extend about the outer surface 520. As is shown, for certain microchannels 530, there may be no direct line of sight between the fluid feed cavity 570 and the microchannel 530 because of the configuration of the squealer rails 522. However, there may be a direct line of sight between the fluid feed cavity 570 and one of the pockets 540 because the pocket 540 may extend outward beyond one side of the microchannel 530 to provide the direct line of sight therebetween. In this manner, the fluid inlet hole 550 may define a straight path extending between the pocket 540 and the fluid feed cavity 570 to allow cooling fluid to enter the microchannel 530 via the pocket 540. Moreover, Because of the configuration of the squealer rails 522, and the low angle of the fluid inlet hole 550 extending from the fluid feed cavity 570, reliable drilling of the fluid inlet hole 550 into certain microchannels 530 may be particularly challenging. However, reliable drilling of the fluid inlet hole 550 into one of the pockets 540 along the microchannel 530 may be achieved because the pocket 540 may extend outward beyond one side of the microchannel 530 to provide a larger target for drilling. In this manner, the fluid inlet hole 550 may define a straight path extending between the pocket 540 and the fluid feed cavity 570 to allow cooling fluid to enter the microchannel 530 via the pocket 540.

The microchannel systems described herein thus provide an improved microchannel configuration for cooling turbine components of a gas turbine engine at high operating temperatures. As described above, the microchannel systems may include a number of pockets positioned along a microchannel extending along an outer surface of a turbine component. The pockets may allow for reliable formation of fluid inlet holes and fluid outlet holes by conventional drilling techniques and thus may reduce fallout of mis-drilled components and associated manufacturing cost. Moreover, the pockets may allow for formation of fluid inlet holes and fluid outlet holes extending to certain locations along the microchannel where there is no direct line of sight between the locations and a respective fluid feed cavity or fluid sink.

Ultimately, the microchannel systems may allow for optimal placement of microchannels and efficient transport of cooling fluid therethrough to increase overall efficiency of the gas turbine engine without the need to develop new drilling techniques.

It should be apparent that the foregoing relates only to certain embodiments of the present application and the resultant patent. Numerous changes and modifications may be made herein by one of ordinary skill in the art without departing from the general spirit and scope of the invention as defined by the following claims and the equivalents thereof

We claim:

1. A microchannel system for cooling a hot gas path surface of a turbine, the microchannel system comprising:
a turbine component comprising an outer surface extending along a hot gas path of the turbine;
a microchannel defined within the turbine component and extending about the outer surface; and
a plurality of pockets defined within the turbine component and positioned along the microchannel.

2. The microchannel system of claim 1, wherein the pockets are spaced apart along a length of the microchannel.

3. The microchannel system of claim 1, wherein each of the pockets encompasses a portion of the microchannel.

4. The microchannel system of claim 1, wherein each of the pockets is offset to one side of the microchannel.

5. The microchannel system of claim 1, wherein:
the microchannel has a first cross-sectional area,
each of the pockets has a second cross-sectional area, and
the second cross-sectional area is greater than the first cross-sectional area.

6. The microchannel system of claim 1, further comprising:
a fluid feed cavity defined by the turbine component, and
a fluid inlet hole defined within the turbine component and extending between the fluid feed cavity and one of the pockets.

7. The microchannel system of claim 6, wherein there is no direct line of sight between the fluid feed cavity and the microchannel.

8. The microchannel system of claim 1, further comprising:
a fluid sink defined by the turbine component, and
a fluid outlet hole defined within the turbine component and extending between the fluid sink and one of the pockets.

9. The microchannel system of claim 8, wherein there is no direct line of sight between the fluid sink and the microchannel.

10. The microchannel system of claim 1, wherein the turbine component is a turbine shroud.

11. The microchannel system of claim 1, wherein the turbine component is a turbine nozzle.

12. The microchannel system of claim 11, wherein the microchannel is defined within a sidewall overhang of the nozzle.

13. The microchannel system of claim 1, wherein the turbine component is a turbine bucket.

14. The microchannel system of claim 13, wherein the microchannel is defined within a tip of the bucket.

15. A method of forming a microchannel system for cooling a hot gas path surface of a turbine, the method comprising:
forming a turbine component comprising an outer surface extending along a hot gas path of the turbine;
defining a microchannel within the turbine component and extending about the outer surface; and
defining a plurality of pockets within the turbine component and positioned along the microchannel.

16. The method of claim 15, further comprising drilling a fluid inlet hole defined within the turbine component and extending between a fluid feed cavity and one of the pockets.

17. The method of claim 15, further comprising drilling a fluid outlet hole defined within the turbine component and extending between a fluid sink and one of the pockets.

18. A microchannel system for cooling a hot gas path surface of a turbine, the microchannel system comprising:
a turbine component comprising an outer surface extending along a hot gas path of the turbine;
a plurality of microchannels defined within the turbine component and extending about the outer surface; and
a plurality of pockets defined within the turbine component and positioned along each of the microchannels.

19. The microchannel system of claim 18, wherein each of the pockets encompasses a portion of the respective microchannel.

20. The microchannel system of claim 18, wherein each of the pockets is offset to one side of the respective microchannel.
